(19) United States
(12) Patent Application Publication
(10) Pub. No.: US 2024/0216840 A1
(43) Pub. Date: Jul. 4, 2024

(54) A SEPARATOR WITH BYPASS PROTECTION

(71) Applicant: Inheriting Earth Limited, St Philips (GB)

(72) Inventors: Reuben D'Orton-Gibson, Bristol (GB); Michael Lawrance-Owen, Bristol (GB); Reuben Kettle Aiers, Bristol (GB); Fergal Feeney, Bristol (GB); Adam Root, Bristol (GB)

(73) Assignee: Inheriting Earth Limited, St Philips, BS (GB)

(21) Appl. No.: 18/557,981

(22) PCT Filed: Apr. 29, 2022
(86) PCT No.: PCT/EP2022/061496

§ 371 Date: Oct. 30, 2023

(30) Foreign Application Priority Data
Apr. 30, 2021 (GB) 2106280.7
Nov. 12, 2021 (GB) 2116312.6

(51) Int. Cl. B01D 29/68; B01D 29/88

(52) U.S. Cl. CPC B01D 29/682; B01D 29/885; B01D 2201/081; B01D 2201/16; B01D 2221/02

(57) ABSTRACT

A separator prevents microplastics from entering the environment by regenerating the pressure consumption of filters for removing microplastics in effluent from any source but in particular removing microfibers from washing machine wastewater. The separator separates microplastics from an effluent and includes: a chamber with an inlet and an outlet, a sieve structure forming a permeable barrier between the inlet and the outlet to filter the effluent, the sieve structure thus having an inlet side for unfiltered effluent and an outlet side for filtered effluent, wherein a bypass conduit is provided between the inlet and the outlet to provide an alternative route for effluent in the event that the flow of fluid is impeded.

### BACKGROUND

### Field of the Invention

The invention relates to preventing microplastics from entering the environment. In particular the invention is directed to regenerating the pressure consumption of filters for removing microplastics in effluent from any source but in particular removing microfibers from washing machine wastewater.

### Description of Related Art

Microfibers are the most abundant form of microplastic pollution in rivers and oceans. Due to their microscopic scale, microfibers are eaten by organisms at all levels of the food chain, from plankton to top predators. Once ingested, plastics reduce feeding efficiency (false satiation) they may damage the gut of the animal and transfer harmful additives like PCBs, pesticides, flame retardants to the animal that consumed it. Plastics consumed by animals low in the food chain also impact their predators, which consume numerous contaminated prey daily. The pervasiveness of microfibers in the food chain has naturally resulted in concern regarding their transfer to humans, and contamination has been observed in crustaceans, molluscs and fish species destined for human consumption.

Unlike microbeads, which are easily excluded from toiletries and cleaning products, microfibers are formed through damage to clothing. One third of all microplastics in the oceans come from washing of synthetic textiles. Synthetic fabrics derived from petrochemicals make up 65% of all textiles. Wear and tear caused by abrasive forces in washing machines result in the fragmentation of man-made textiles, forming hundreds of thousands of microfibers, less than 5 mm in length, which leak from homes and drainage networks into the ocean.

The vast impact of microplastics on marine ecosystems is starting to be understood. A 2019 study published in the ‘Science of the Total Environment’ journal found 49% of 150 fish samples from the North East Atlantic Ocean contained microplastics with evidence of this causing harm to brain, gills, and dorsal muscles. These microplastics are also passed onto people consuming fish at a rate of between 518-3078 microplastic items/year/capita.

The impact is not just being seen in fish stocks but also algae, the building blocks of life. A 2015 study published in the ‘Aquatic Toxicology’ journal demonstrated high concentrations of polystyrene particles reduced algal growth up to 45%. This should be of concern as microalgae are one of the world's largest producers of oxygen on this planet.

Wastewater treatment plants cannot remove the millions of fibres that pass through them every day. Currently, secondary level water treatment removes around 98% of the microplastics that pass through them. However, the small proportion that escapes still equates to tens of millions of fibres per treatment works per day.

Furthermore, wastewater treatment plants produce a “sewage sludge” and plastic microfibers are found on discharge when released into the natural environment when the sludge is spread on agricultural land, thus microfibers make their way into the food chain, waste to energy (which can destroy fibres but release harmful gasses) or discharged into rivers or the ocean.

Current washing machine filters are designed to stop pennies and buttons breaking the washing machine pump. These filters often have open aperture of 7-14 mm which is too large to effectively capture large amounts of microfibers. The filtration required to stop microfibers is typically less than 400 micrometers (um). Reducing the aperture size will remove a larger proportion of the fibers in the water.

It is known to provide mesh filters that stop the problem at source. However, mesh filters clog up quickly and when this happens their effectiveness drops off considerably. This causes the pressure to rise and the flow rate to reduce, which can lead to damage to pumps and delays to the wash cycle. Washing machines are found in domestic and commercial settings.

A typical front-loading domestic washing machine is shown in FIG. 1 in schematic form. The machine 100 includes a rotatable sealed drum unit 101 for receiving garments to be washed. The drum unit 101 has a perforated cylindrical rotatable drum mounted inside a static waterproof shroud. Clean water is fed into the drum 101 via a cold water or hot water inlet 102 connected to mains and under mains pressure of typically 1-5 bar. The water entering the drum 101 is managed by an electronic valve, under the control of a CPU 104. The inlet 102 is connected to a drawer 105 where liquid or powdered detergent can be added by a user. The drawer has an outlet that leads to the drum unit 101. The drum unit may include a heater under the control of the CPU to heat the water to the desired wash temperature, typically up to 90 degrees Celsius. The drum is rotatable by an electric motor 106 under the control of the CPU 104 at speeds of typically from 5 to 1600 rpm. The drum unit can be emptied via a drain pump 108 both controlled by the CPU. The drain pump is rated with a given power to produce a known pressure at its output. The drain pump feeds into an outlet 109 which is connected to the household or industrial drain and eventually the wastewater network.

A typical top-loading machine will have the axis of the drum vertical but will otherwise share many of the features of the front-loading machine.

In use, dirty laundry is placed in the drum, and a wash cycle initiated by a user. The CPU allows cold water to flow via the drawer to mix with detergent and then on into the drum, where the water is heated. The combined water, detergent and laundry is agitated by rotating the drum. During this process, dirt and grease is released into the water and fibres from the clothing too. If the clothing is synthetic, microfibers are typically released as the clothes rub against each other. The resulting effluent at the end of the wash cycle is a mixture of debris, dirt, grease and microfibers and potentially large objects such as coins or nails left in the clothing. This effluent is then drained and pumped out of the drum at a typical rate of 3-8 gallons per minute. Second or third rinse cycles with clean water may be performed, resulting in effluent with less concentrated contaminants. The drain rate of the washing machine is impacted by the level of water in the drum, the height of the outlet point and if a filter is connected to the outlet.

In a typical wash, the highest concentration of microfibers is in the range 5 mm to 50 um but shorter microfibers exist that are still harmful in the environment. If it were required to remove 99% of microfibers of all sizes down to 50 um in length, a mesh with apertures of 25 um would theoretically be able to achieve this. In practice however, such a mesh placed directly in the stream of effluent will clog almost immediately and the filter will become inoperable. This will create a rise in pressure consumption in the outlet and potentially damage the pump and cause flooding.

A conventional separator or filter arrangement is shown in FIG. 2. An inlet 201 directs effluent into a filter housing 202, within which a sieve structure 203 is supported. The sieve structure could be a mesh or other perforated material where the mesh opening size is selected to trap particles of a required dimension. Filtered effluent passes through the sieve structure 203 to an outlet 204. The filtered waste accumulates on what is called the unfiltered side of the sieve structure, while the outlet side of the sieve structure is called the filtered side. Filter efficacy is its effectiveness at removing debris of a given size range while maintaining an acceptable flow rate and is closely related to the filter's pressure consumption. The sieve structure shown in FIG. 2 will become blinded over by filtered debris rapidly, so that its pressure consumption will increase.

Curve 1 in FIG. 3 is a measure of the effectiveness of the arrangement shown in FIG. 2, given a constant flow of dirty water, with a consistent contamination level. The y-axis represents the fluid pressure, P, at the inlet 201 and it can be seen to rise gradually, then exponentially as the mesh becomes blinded over with filtrate.

In practice, the flow of effluent from a washing machine is not constant over time because a limited amount of water is used in each wash cycle. Curve 2 in FIG. 3 shows how the inlet pressure varies over time where the flow of effluent stops, drains through the device and then starts again. Reductions in the pressure can be seen, as the flow stops and debris previously held against the mesh by the pressure of the flow falls away, revealing pores that allow fluid to flow through again, until they become re-blocked in the next cycle. Curve 2 demonstrates that the pressure consumption required by the conventional device increases through use, so the inlet pressure required to filter effluent eventually becomes greater than the pump is able to provide.

If the pressure builds up too much in the filter then flooding can occur. It is an object of the invention to solve the problem of damage to property caused by a clogged filter.

### SUMMARY OF THE INVENTION

In an embodiment, a separator is provided for separating solid material from a fluid, the separator comprising: a chamber with an inlet and an outlet, a sieve structure forming a permeable barrier between the inlet and the outlet to filter the fluid, the sieve structure thus having an inlet side for unfiltered fluid and an outlet side for filtered fluid, the separator further comprising a filter pressure regeneration apparatus for dislodging filtered material from the sieve structure, wherein the filter pressure regeneration apparatus comprises a conduit and a nozzle assembly having at least one cleaning nozzle for directing fluid towards the outlet side of the sieve structure, and wherein the separator is characterised in that the sieve structure has a circular cross-section, and wherein a channel is formed between the chamber and the sieve structure such that in use the fluid is guided circumferentially around the sieve structure through the channel, and wherein a bypass conduit having a valve is provided between the inlet and the outlet to provide an alternative route for fluid in the event that the flow of fluid is impeded. The description herein is directed towards filtering microplastics from effluent, but the separator may be applied to separate any solid material from any fluid.

The bypass conduit may include a pressure-activated valve.

The bypass conduit may include a gravity bypass tube.

The bypass conduit may include a series of gravity bypass tubes.

The bypass conduit may include a Pitot tube.

The bypass conduit may include a venturi.

The bypass system may include an electronically controlled valve.

A sensor such as a fluid level detector may be provided, and the filter pressure regeneration apparatus may be arranged to be activated in accordance with the output from the fluid level detector.

A reservoir may be provided below the chamber and the sensor may be located in the reservoir.

The fluid level detector may be a float switch.

The filter pressure regeneration apparatus may comprise a conduit and a nozzle assembly having at least one cleaning nozzle directed towards the outlet side of the sieve structure.

The chamber may be cylindrical and the sieve structure may be a coaxial cylinder within the chamber and wherein a wall may be provided to one side of the inlet such that the fluid may be guided around the sieve structure through a channel such that filtered solid dislodged by the wash water from the cleaning nozzle accumulates on the side of the wall away from the inlet. The advantage of this arrangement, whereby filtered solid materials progress along a channel, is the better use of space, increased solid material collection capacity and ease of handling filtered solids.

A trap may be provided comprising an opening in the base of the channel to a sub-chamber, where the accumulating filtered solid can be collected.

The nozzle assembly may comprise a plurality of cleaning nozzles that are rotatable around the central axis of the sieve structure.

A pump may be provided in fluid communication with the outlet of the chamber.

The pump may be a water pump arranged to drain the separator.

The pump may be arranged to recirculate the filtered fluid to the conduit of the filter pressure regeneration apparatus.

A restriction may be provided in a conduit downstream from the pump, wherein the aperture of the restriction may be set to ensure that a preset amount of filtered fluid is recirculated into the filter pressure regeneration apparatus and an amount of the filtered fluid is drained.

An air vent may be provided in a conduit between the pump and the filter pressure regeneration apparatus to introduce air into the conduit.

A second pump may be arranged to recirculate the filtered fluid to the conduit of the filter pressure regeneration apparatus.

The separator may further comprise an air pump located between the pump and the filter pressure regeneration apparatus to introduce air into the conduit and to drain the separator.

The nozzle assembly may comprise a nozzle arranged to direct a stream of fluid towards a rotatable plate, wherein the plate is arranged to rotate under the force of the stream of fluid and to project the fluid outwards towards the sieve structure.

In an embodiment, a washing machine with a separator is provided.

In an embodiment, a method of operating a separator of the type described above is provided, comprising the steps of, filtering fluid through a sieve structure, allowing the fluid to bypass the sieve structure when the pressure at an inlet of the sieve structure exceeds a predetermined threshold.

The method may further comprise the step of allowing the fluid to bypass the sieve structure through a passive bypass system.

The method may further comprise the step of detecting the pressure at the inlet using a sensor and controlling an electronic valve in a bypass conduit when the pressure differential reaches the predetermined threshold.

### BRIEF DESCRIPTION OF THE DRAWINGS

FIG. 1 shows a typical domestic washing machine.

FIG. 2 shows a conventional separator.

FIG. 3 is a graph showing the efficacy of different types of filter assembly.

FIG. 4 shows a bypass system comprising a pressure-activated valve.

FIG. 5 shows a bypass system comprising an upstanding tube.

FIG. 6 shows a bypass system comprising a pair of upstanding tubes joined by an anti-syphon chamber.

FIG. 7 shows a bypass system comprising a Pitot tube.

FIG. 8 shows a bypass system comprising a Venturi.

FIG. 9 shows an embodiment with a drain system and bypass.

FIG. 10 shows a cross section of an embodiment having a pressure consumption regeneration apparatus and a bypass.

FIG. 11 shows an embodiment having a cylindrical sieve structure and an array of rotating cleaning nozzles and a bypass system.

FIG. 12 shows the embodiment of FIG. 11 with a recirculation system.

FIG. 13 shows an embodiment of a separator with combined recirculation and drain pumps with a bypass system.

FIG. 14 shows an embodiment of a separator with a single pump and a restriction in the outlet.

FIG. 15 shows an embodiment of a separator with separate recirculation and drain pumps with a bypass system.

FIG. 16 shows an embodiment of a separator with a liquid recirculation pump and an air drain pump, with a bypass system.

FIG. 17 shows an embodiment having a bypass system operated by a float switch.

FIG. 18 shows a washing machine equipped internally with an embodiment of the separator

FIG. 19 shows a washing machine retro-fitted externally with an embodiment of the separator.

FIG. 20 is a perspective view of a filter assembly having a nozzle assembly with a rotatable plate.

FIG. 21a is a perspective view of an embodiment of a separator unit.

FIG. 21b is a perspective view of the embodiment of FIG. 21a with the jug removed.

FIG. 22a is a section view of the embodiment of FIG. 21a.

FIG. 22b is a perspective view of the pump and ducting assembly of the embodiment of FIG. 21a.

FIG. 23 is a perspective view of a part of a filter assembly of the embodiment of FIG. 21a.

FIG. 24 is a perspective view of a nozzle assembly of the embodiment of FIG. 21a.

FIG. 25 is a top view of the jug of FIG. 21b with a cap removed.

FIG. 26 is a view of a printed circuit board in place in a component of the embodiment of FIG. 21a.

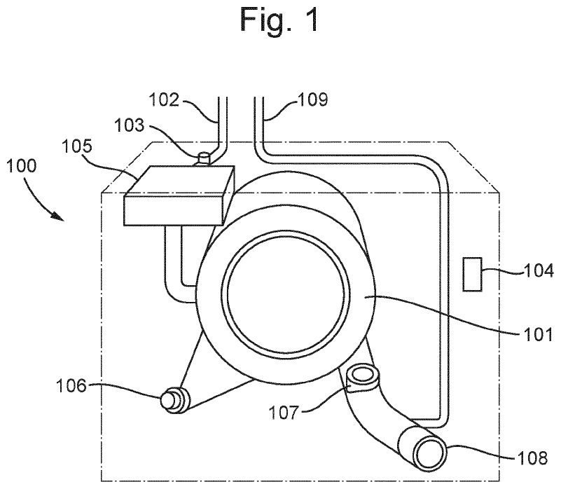

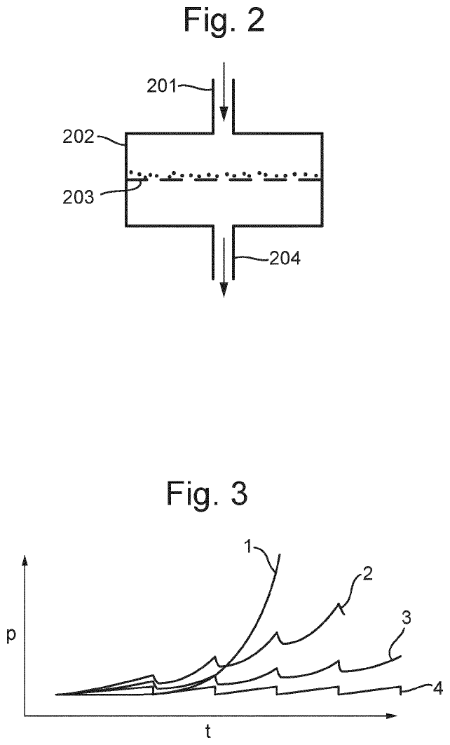

### DETAILED DESCRIPTION OF THE PREFERRED EMBODIMENT

While the description that follows focuses on washing machines for clothes, it is to be understood that the teachings herein are not limited to use in washing machines as they are equally suited to other processing appliances, such as but not limited to driers, such as wash-dryer combination machines, tumble driers, dyeing machines, cutting machines, recycling machines, dry cleaning machines and so on. The washing machines or other processing appliances could be domestic or commercial. The teachings herein could also be used in other industries in which microparticles may be generated as a result of processing of items. References to washing machines herein are therefore to be understood as comprising any similar appliance of the types contemplated herein.

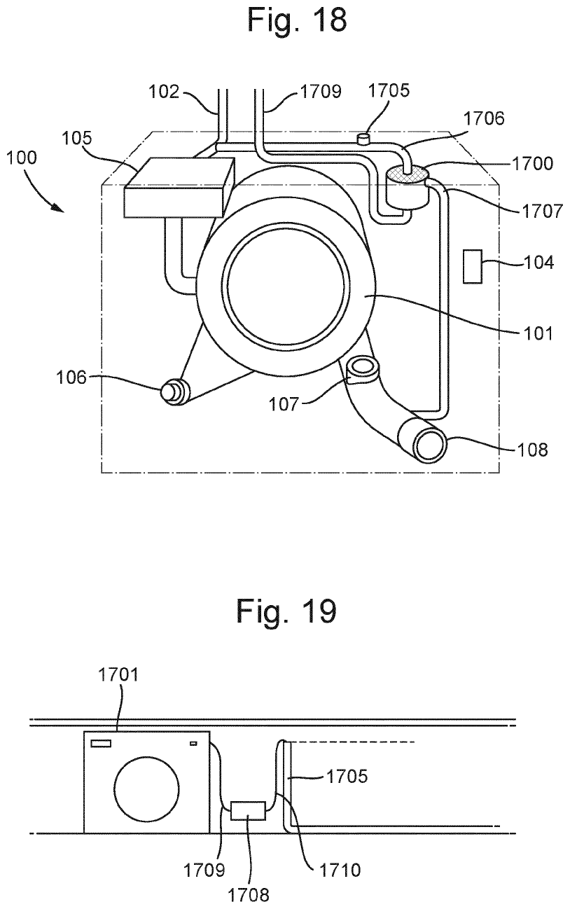

The separator described herein may be installed within the appliance itself during manufacture as shown in FIG. 18, or retro-fitted externally to a washing machine or other appliance, as shown in FIG. 19.

The separator system 1700 described above may be installed within a washing machine, as shown in FIG. 18. The waste from the washing machine drum connects to the inlet 1707 of the separator 1700 and the outlet of the separator connects to the waste outlet 1709. A supply of fresh water 1706 for the regeneration apparatus is shown but if the recirculation system is used then this supply is unnecessary. A separator system 1708 may be located outside a washing machine, connected to the waste water outlet of the washing machine, as shown in FIG. 19. The inlet 1709 supplies effluent into the separator 1708 and the outlet 1710 feeds into the soil pipe 1705. The embodiment shown is fitted with a drain pump to enable installation below the dotted water line in the figure, i.e. the top of the soil pipe. The embodiment shown also has a recirculation system therefore a separate supply of fresh water is not needed. The device may be connected to an electrical power supply (not shown) to operate the pump or pumps.

It will further be appreciated that the teachings herein are suited to any application which requires the removal of microplastics, including microfibers, from any effluent, including wastewater, within which such materials may be entrained.

It should be noted that wastewater from a washing machine, and other applications, contain a wide variety of compounds including microplastics. Although the filter is specifically suited to the capture of microplastic, due to the environment in which it operates, this system is also robust against the harsh and varied compounds the filter comes into contact with and is also suited to filtering out any solid material entrained in an effluent.

Effluent is understood to include wastewater from the sources mentioned above. It can also include the wastewater from Wastewater Treatment Plants. Effluent includes entrained dirt, detergent and micropollutants including microplastics, which include microfibers.

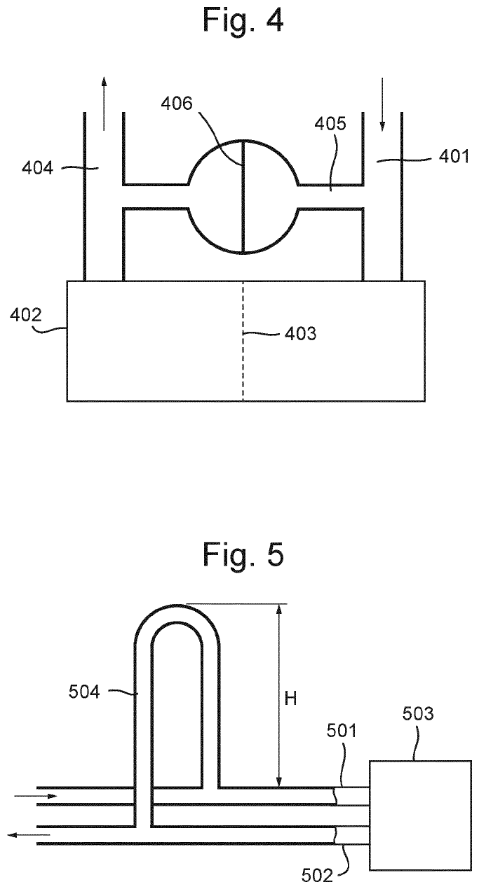

FIG. 4 shows an embodiment of a separator unit having a bypass feature for allowing effluent to go around the filter if it becomes clogged. The separator unit has an effluent inlet 401, a housing 402 supporting a sieve structure and an outlet 404. A bypass conduit 405 links the inlet 401 to the outlet 403. A pressure-activated valve 406 is located in the conduit 405. An example valve is an X-Fragm valve. The pressure-activated valve opens when the pressure at the inlet exceeds a certain pre-set value. Therefore, if effluent backs up at the inlet because the filter is clogged, the valve will open and let effluent through to the outlet where it can safely discharge to a waste pipe.

In this embodiment the pressure activated valve may be designed with a cross sectional profile that enables the valve to invert and thus open, allowing the flow of effluent. Upon the reduction in pressure the valve would then automatically self-close and return to the original orientation.

The opening pressure threshold can be controlled through varying the flexibility or shore hardness of the flexible material from which the component is manufactured.

The bypass may be a binary mechanism which is either open or closed to fluid flow. Alternatively, the bypass may operate on a on a graduated basis where it allows varying amount of fluid to pass depending on the pressure applied to the bypass mechanism.

The bypass may be monitored to establish whether it is in an open or closed state. This sensing system that might include a fluid sensor, mechanical sensor, or pressure sensor. This would enable the bypass to be in communication with the washing machine.

In another embodiment a sensing system may be used to predict the operation of the bypass mechanism and inform the user ahead of a bypass event that the filter needs emptying.

Alternatively, the valve 406 may be of a type that can be electronically controlled. A pressure sensor that detects a pressure differential between the two sides of the sieve structure can control the valve, so that if the pressure differential reaches a predetermined level, the valve is operated and the bypass activated. In this embodiment a sensing system may be used to control the operation of the bypass by software logic.

FIG. 5 shows another embodiment with an alternative bypass system, where an upstanding tube 504 links the inlet 501 to the outlet 502 of a separator unit 503. The height “H” of the tube determines the pressure at which the bypass operates. A disadvantage of this system is that a significant height is required above the separator unit to fit the tube 504, which can be a problem when a washing machine is located in a confined space.

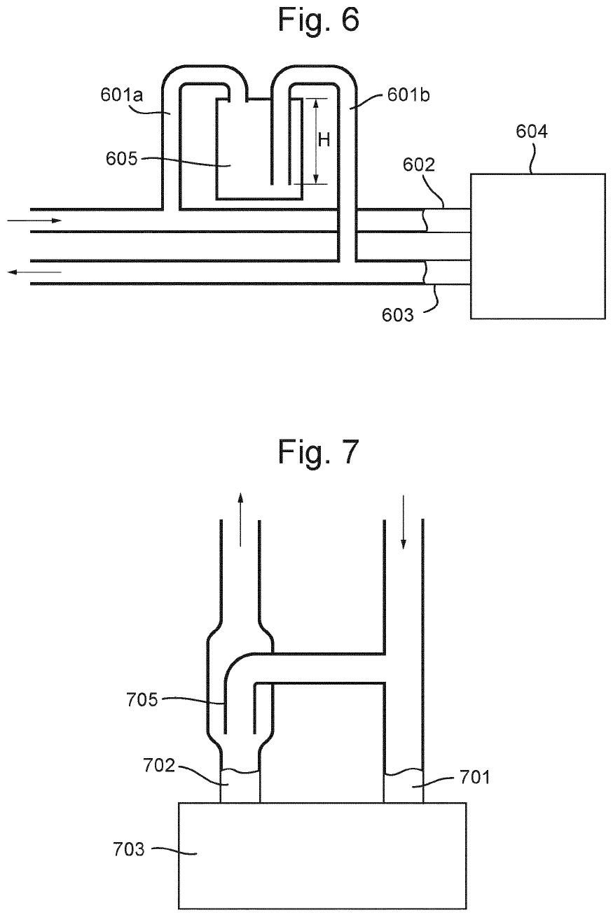

FIG. 6 shows another embodiment with a further alternative bypass system, with a lower profile for fitting in confined spaces. The system comprises a pair of upstanding tubes 601a, 601b that link the inlet 602 to the outlet 603 of a separator unit 604. The tubes are connected by chamber 605. The first upstanding tube 601a empties effluent into the top of the chamber 605 at height “H”. When effluent reaches the height “H” of the second tube 601b it will pass through to the outlet 603. This arrangement creates an anti-syphon and means that filtered effluent must have sufficient pressure to reach 2×H.

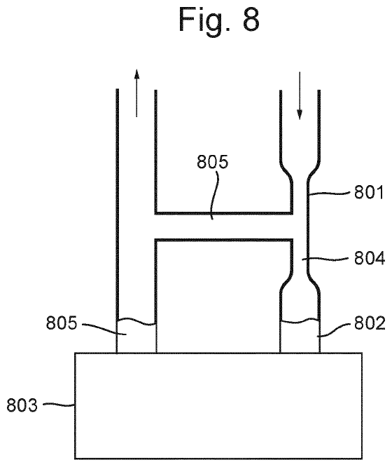

The above embodiments work by creating an obstruction to the flow of the effluent. This may be undesirable from the point of view of washing machine manufacturers who often stipulate that anything connected to the outlet of their machines must not cause an obstruction. FIGS. 7 and 8 shows a bypass system that uses the pressure of the flow of the incoming effluent to maintain an obstruction until the lowering flow rate associated with a blockage decreases. FIG. 7 is a bypass system that comprises a Pitot tube in the outlet 702 from a separator 703. The Pitot tube is connected to the inlet 704 of the separator 703. While the filtered effluent is flowing out of the outlet into the Pitot tube the pressure is enough to prevent the fluid from bypassing the separator from the inlet to the outlet. When filtered effluent stops flowing out of the outlet because of a blockage in the separator, there will be no reverse pressure in the Pitot tube and the effluent will be free to flow directly from the outlet to the inlet.

FIG. 8 shows a further embodiment that uses the Venturi effect to operate a bypass system. A tube 801 connects to the inlet 802 of a separator 803. A restriction 804 is provided in the tube 801. A conduit 805 is provided between the restriction and the outlet 805 of the separator 803. When the separator is operating normally, the unfiltered effluent flowing through the restriction 804 to the inlet will have a lower pressure than the filtered effluent flowing out of the outlet, so the bypass will not operate. If the separator blocks and filtered effluent slows the pressure at the inlet will rise and the bypass will operate.

The bypass may be used to both provide passage for effluent directly to the outlet of the device when the filter membrane becomes blocked and also when the device is opened by the user during disassembly for maintenance or emptying. The bypass is advantageous as it can be used to stop the flow of water from exiting the device through the disassembled product, which would otherwise result in a leak or flood.

Another benefit of the bypass is that it regulates the pressure seen by the filter system. If for example the opening pressure of the bypass is set to be 6 Kpa, this would also be the maximum pressure typically experienced by the filter mesh and regeneration system. By limiting this pressure, so is also limits the force at which effluent is applied to the mesh. This is advantageous as the regeneration system and wash fluid velocity can be optimised to work at this maximum application force.

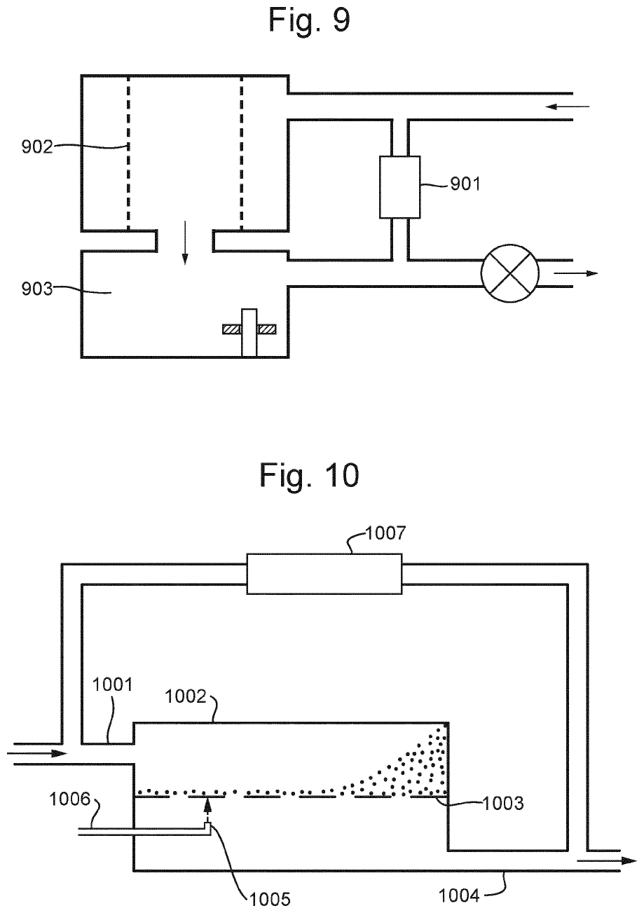

FIG. 9 shows an embodiment of a separator that can be fitted to a washing machine below the waterline and includes a bypass system that could be any one of the type described above. The separator includes a reservoir 903 with a sensor for detecting when there is fluid in the reservoir. A pump is provided that is arranged to operate when fluid is detected in the reservoir and thus the separator will always be emptied of fluid ready for emptying of filtered microplastics. The bypass system ensures that if the pump and sensor arrangement fails, the entire wash load of effluent will not back up and cause a flood. The sensor could be a float switch in the reservoir or a pressure sensor.

FIG. 10 shows an embodiment of a separator having a filter pressure regeneration system and that includes a bypass system that could be any one of the type described above. It comprises an effluent inlet 1001 feeding a channel bounded by a filter housing 1002 and a sieve structure 1003. The filtered effluent exits from the separator via an outlet 1004. A cleaning nozzle 1005 is provided that is arranged to direct a cleaning jet of wash fluid towards the filtered side of the sieve structure 1003. The cleaning nozzle 1005 is connected by conduit 1006 to a supply of wash fluid. The cleaning nozzle is periodically supplied with cleaning fluid to dislodge filtered material from the unfiltered side of the sieve structure, which allows more effluent to be filtered out and thus regenerate the pressure consumption. As the waste material is dislodged, the flow of effluent carries it further away from the inlet towards the far end of the channel. The bypass system 1007 connects the inlet to the outlet. It ensures that if the regeneration system fails for some reason, the entire wash load of effluent will not back up and cause a flood or delay to wash cycle.

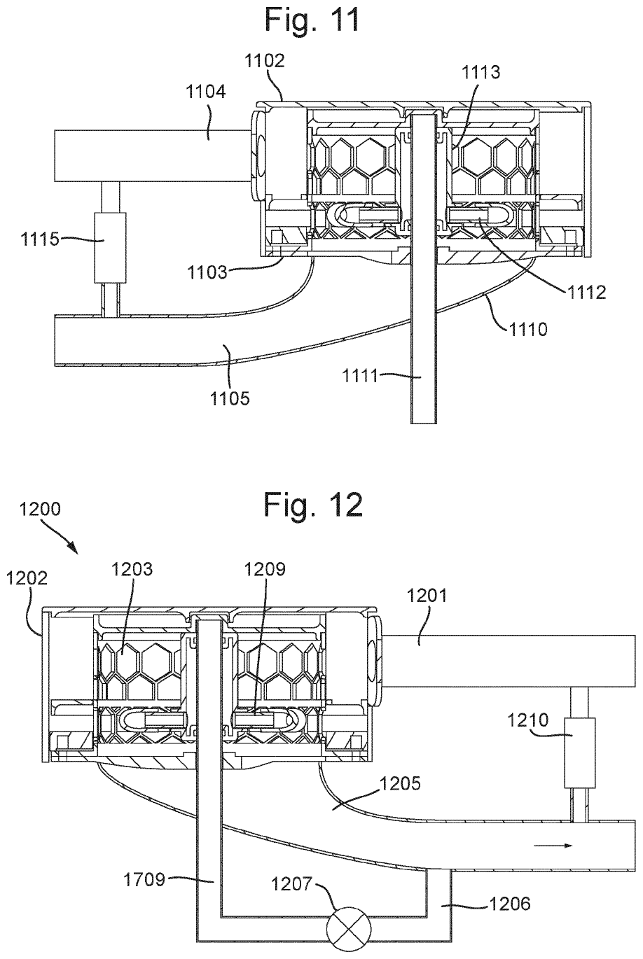

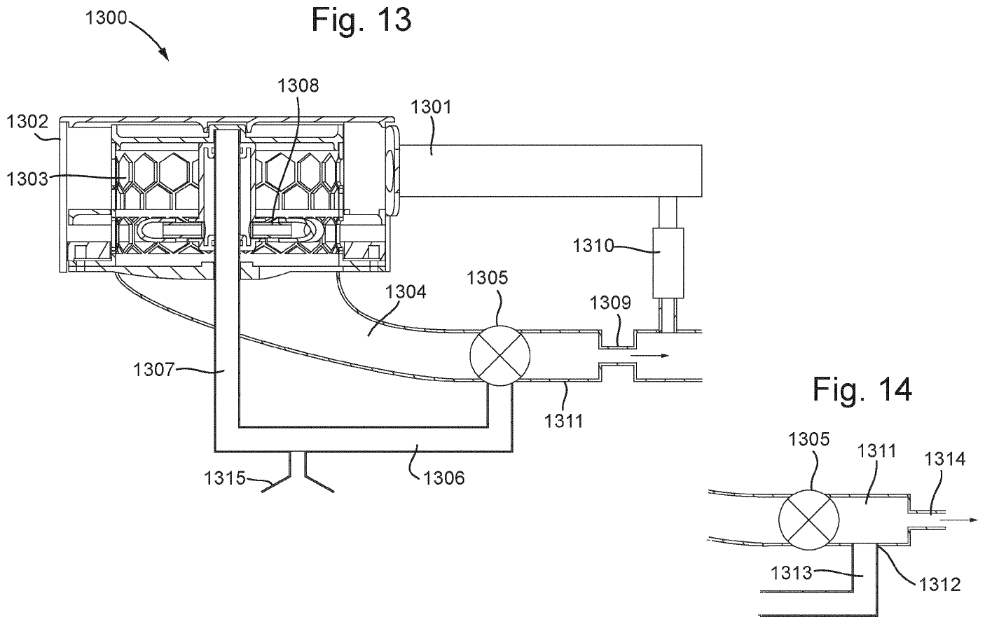

FIG. 11 shows an embodiment of a separator unit that includes a filter pressure regeneration system and a bypass system. The separator unit 1100 comprises an outer cylindrical wall 1101. In this embodiment the outer wall is transparent so that a user can see when the separator is operational and can also see the accumulated filtered waste. The separator unit 1100 has a circular cap 1102 and base 1103. An inlet 1104 is provided in the wall 1101. An outlet 1105 is provided in the base 1103.

A cylindrical sieve structure is provided coaxially with the outer wall 1101. The sieve structure extends between the cap 1102 and the base 1103 and provides a seal beyond which unfiltered effluent cannot pass. The sieve structure comprises an open support scaffold to which is fixed a mesh of aperture 25 micrometers. Mesh sizes in the range 5-75 micrometers are also suitable. The mesh separates the solid material from the liquid component of the effluent. An interior dividing wall 1107 creates a channel for the effluent to flow around the sieve structure, starting at the inlet 1104. The chamber is divided horizontally into two parts by a partition 1108. The partition 1108 has an opening on the other side of the interior dividing wall 1107. The combination of the opening and the lower part of the chamber beneath the partition 1108 provide a trap 1109 within which waste material can accumulate. The outlet 1105 is connected to a scoop 1110 that collects filtered effluent that passes through the mesh. A central vertical conduit 1111 provides wash fluid to the nozzle assembly. The nozzle assembly includes propulsion nozzles 1112 mounted on a rotatable hub 1113. The nozzle assembly includes cleaning nozzles (not shown) mounted on the rotatable hub 1113. The cleaning nozzles extend radially out from the hub to be proximal to the filtered side of the sieve structure.

The separator unit is around 15 cm in diameter. However, it will be appreciated that larger or smaller diameters could be selected depending on the application. The size of the unit is selected on the flow rate of effluent to be filtered. A separator diameter of 15 cm is sufficient to process the effluent from a domestic washing machine flowing at a rate of 13 litres per minute.

The open area of the mesh that enables the passage of water at a given flowrate can be adjusted by changing either the surface area of the mesh or the mesh aperture. The mesh aperture effects the efficiency, so a smaller mesh aperture is generally preferable to provide greater efficiency. The mesh surface area is a function of the height and diameter, therefore a given area can be matched by increasing the height if the diameter is reduced, and visa versa. All variables can be adjusted to meet product packaging and efficiency specification requirements.

The bypass system 1115 connects the inlet to the outlet. It ensures that if the regeneration system fails for some reason, the entire wash load of effluent will not back up and cause a flood.

In another embodiment, the filtered effluent is used to wash the sieve structure. FIG. 12 shows a separator unit with an inlet 1201, a cylindrical housing 1202 and a sieve structure 1203. An outlet 1205 collects filtered effluent. A portion of the filtered effluent is diverted into conduit 1206, where it is pressurised by pump 1207 and directed into the central vertical conduit 1208 that provides wash fluid to the nozzle assembly 1209. The bypass system 1210 connects the inlet to the outlet. It ensures that if the regeneration system fails for some reason, the entire wash load of effluent will not back up and cause a flood. This embodiment is not suitable for location below the waterline because the outlet is not pumped, it must drain by gravity.

FIG. 14 shows an embodiment that is suitable for location below the waterline and that also recirculates some of the filtered wastewater to regenerate the filter pressure. The separator unit 1300 has an inlet 1301, housing 1302, sieve structure 1303 and outlet 1304. All of the filtered effluent from the outlet 1304 is pumped out via pump 1305. The pump 1305 is arranged to divert a portion of the filtered effluent back via conduit 1306 to the central vertical conduit 1307 that provides wash fluid to the nozzle assembly 1308. A restriction 1309 is provided in the pump outlet pipe 1310 to ensure that an adequate volume of fluid is re-circulated to the pressure regeneration system. Alternatively, the pump 1305 may have a single outlet as shown in FIG. 14 and a junction 1312 that diverts some filtered effluent to conduit 1313 to be re-circulated into the pressure regeneration system and the rest to the soil pipe. A restriction 1314 is provided to determine the proportion of filtered effluent that is re-circulated. An air inlet 1315 in the conduit 1306 may be provided that allows air into the pressure regeneration system to enhance the cleaning effect of the jet of cleaning fluid against the filtered side of the sieve structure. A bypass system 1310 of the type described above connects the inlet to the outlet. It ensures that if the regeneration system fails for some reason, the entire wash load of effluent will not back up and cause a flood.

An electronically controlled diverter valve may be provided to recirculate the filtered effluent to the conduit of the filter pressure regeneration apparatus and/or drain the separator, so that only a single pump is required to drain the separator and to recirculate the waste water to the regeneration system.

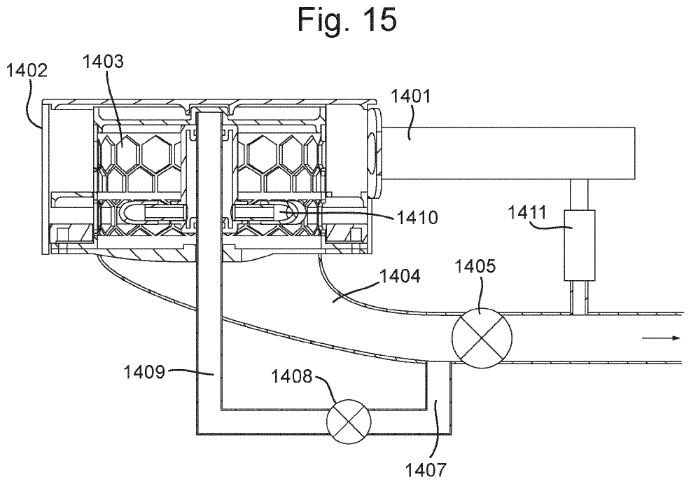

It may be advantageous to be able to control the drainage of a separator unit and the pressure regeneration separately. FIG. 15 shows an embodiment that allows this by the provision of two pumps; a drainage pump 1405 and a recirculation pump 1408. The separator unit has an inlet 1401 into a housing 1402 that supports a sieve structure 1403 that separates the inlet 1401 from the outlet 1404. The outlet 1404 has a conduit that leads to the drainage pump 1405. Also on the filtered side of the sieve structure is a wash fluid conduit 1407 that leads to a wash fluid pump 1408 and on to a further wash fluid conduit 1409 that feeds the cleaning nozzle assembly 1410. The drainage pump 1405 may be a positive displacement pump or a centrifugal pump that operates at around 0.1 Bar 10 litres per minute, but could be in the range up to 1 bar and 15 litres per minute. The recirculation pump 1408 operates at around 0.3 Bar and 5 litres per minute, but could be in the range up to 5 bar and 10 litres per minute. A bypass system 1411 of the type described above connects the inlet to the outlet. It ensures that if the regeneration system fails for some reason, the entire wash load of effluent will not back up and cause a flood.

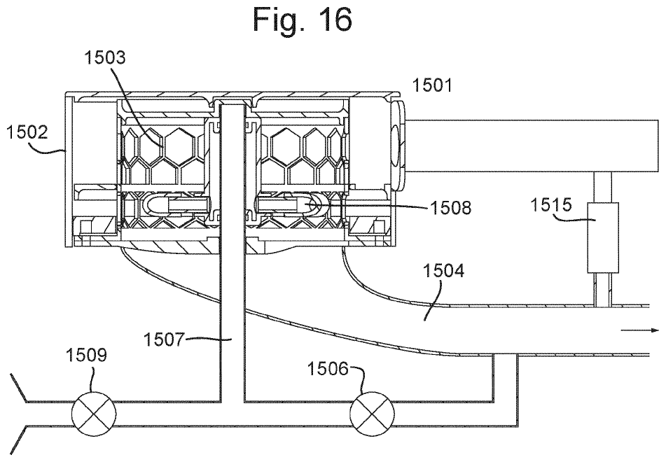

FIG. 16 shows an alternative embodiment of a separator unit where an air pump is used to assist with regeneration and drainage. An inlet 1501 is provided into a housing 1502 that supports a sieve structure 1503 that separates the inlet 1501 from an outlet 1504. A conduit leads to a pump 1506 that pumps filtered effluent into a further conduit 1507 that feeds wash fluid to a cleaning nozzle assembly 1508. An air pump 1509 is connected into the further conduit 1507 to pump air into the wash fluid system. Air enhances the cleaning effect of the wash fluid jet emanating from the cleaning nozzle 1508. The air pump can also be operated to push any remaining fluid in the pipe connected to the outlet 1504 up to the waterline, which enables this embodiment to be mounted below the waterline. A one-way valve would need to be provided at the inlet (not shown) to prevent fluid from being pushed back into the washing machine. The bypass system 1515 connects the inlet to the outlet. It ensures that if the regeneration system or the drainage system fails for some reason, the entire wash load of effluent will not back up and cause a flood.

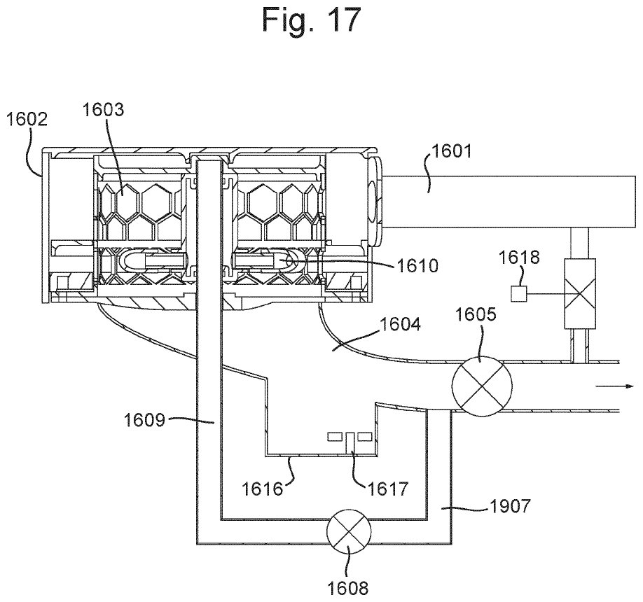

A reservoir 1516 with a fluid detector 1517, which could be a float switch or a capacitative sensor may be provided beneath a separator unit, as shown in FIG. 17. The fluid detector detects when fluid is present in the reservoir. The fluid detector is arranged to control the pump 805 to wash the sieve structure to regenerate the filter pressure. Alternatively a sensor can be provided at the inlet to detect when effluent is present in the system or backing up and this can be used to activate the pump to regenerate the filter pressure. A bypass system may be provided, where an electronically controlled valve 1618 is operated by the fluid detector 1617, so if the level in the reservoir exceeds a predetermined value, then the bypass system operates. A pressure sensor may be provided to operate the valve 1617, where the pressure sensor is arranged to detect the difference in pressure between the unfiltered side of the sieve structure and the filtered side. If the pressure exceeds a predetermined value then the valve is operated and the separator is bypassed.

A separator may be provided where the inlet feeds the interior of the sieve structure and the outlet collects filtered effluent from the outside of the sieve structure.

The separator housing may be opened to empty the trap when the effluent has been drained. An opening at the top of the sieve structure may be provided to avoid air locks.

An air inlet may be provided at the inlet of the separator to avoid syphoning all of the waste water out of a washing machine.

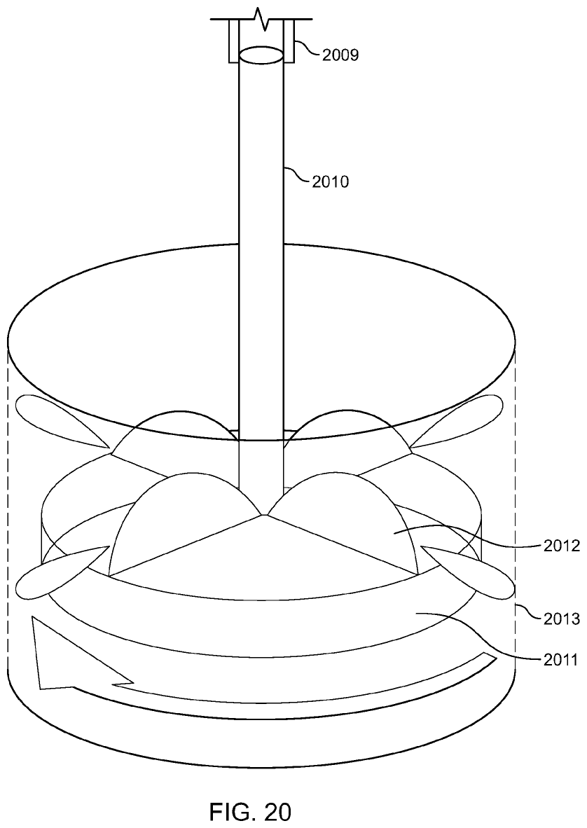

FIG. 20 shows an alternative nozzle assembly having a nozzle 2005 arranged to direct a stream of fluid 2010 towards a rotatable plate 2011. The plate has features 2012 that are arranged to deflect the stream of fluid outwards towards the sieve structure 2013. The features 2012 are also arranged to cause the plate to rotate, so that the projected fluid sweeps across the surface of the outlet side of the sieve structure and thus dislodges debris on the other side.

A more detailed description of a stand-alone separator is provided below:

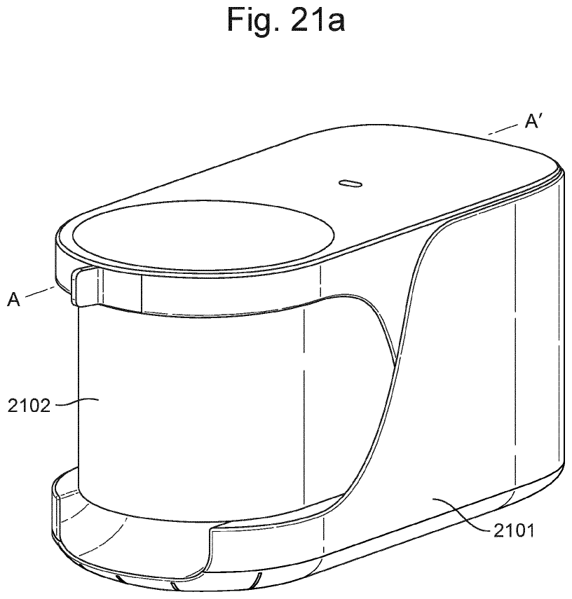

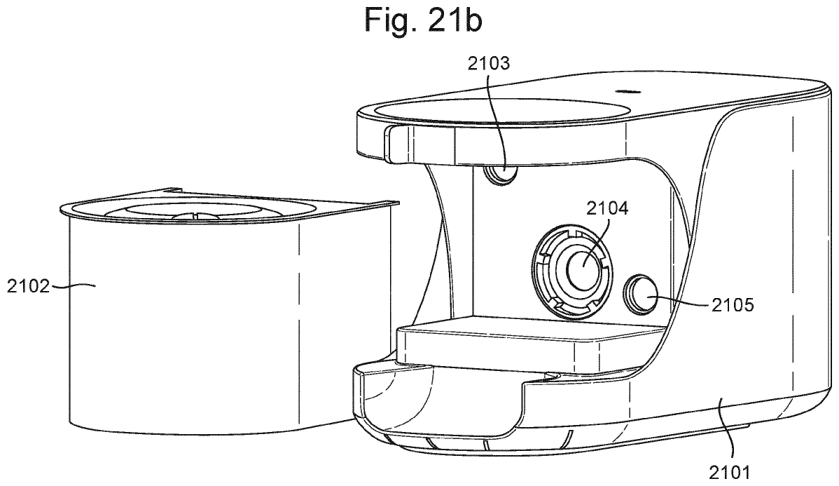

A separator unit for locating externally to a textile processing apparatus such as a domestic washing machine is shown in FIG. 21a. The unit 2100 comprises a body 2101 that has a waste water inlet and outlet (not shown) and a removable jug 2102. The jug includes a filter that can collect filtered microfibers. Removal of the jug allows the filtered microfibers to be emptied. FIG. 21b shows the unit 2100 with the jug removed and separated from the unit. The jug has conduits for effluent inlet, effluent outlet and a pressure consumption regeneration fluid feed. The pressure consumption regeneration fluid is recirculated filtered effluent. The conduits terminate in stubs and the main body of the unit has openings to receive these conduit stubs; effluent inlet 2103, filtered effluent outlet 2104 and recirculated filtered effluent 2105. Each opening has a watertight seal that ensures no fluid leaks from the joints between the stubs and the openings when the jug is in place.

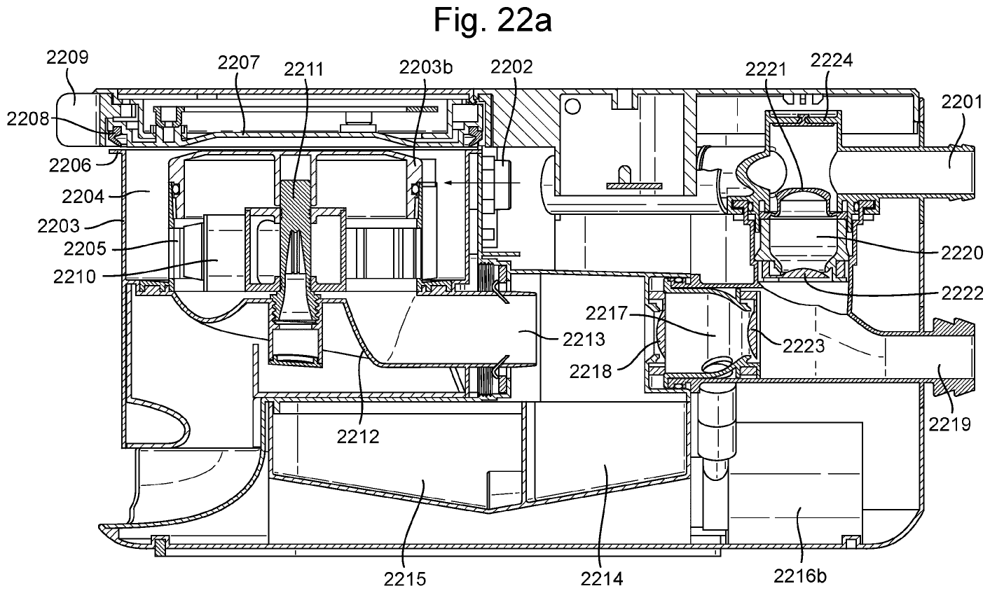

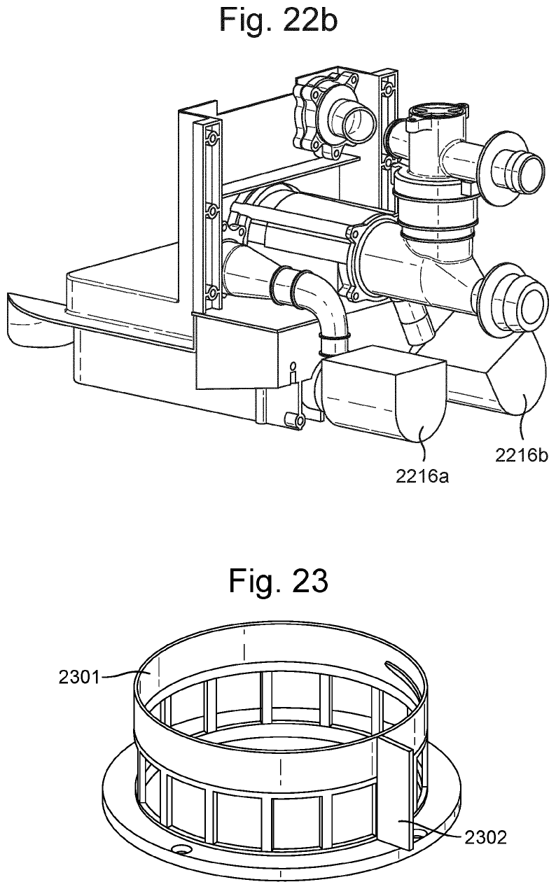

FIG. 22a shows a cross section of the unit 2100 taken along line A-A′ in FIG. 21a. The unit has a waste water inlet 2201 that can be connected to the outlet of a washing machine. A conduit leads to the inlet stub 2202 of the jug 2203 where the waste-water, when the unit is in use, is directed tangentially into a cylindrical chamber 2204 of the jug 2203. Centrally located within the jug 2203 is a cylindrical filter assembly 205, shown in more detail in FIG. 23. It is a plastic cage 2301 having a series of openings between a set of vertical ribs. A mesh (not shown) is overmoulded to the plastic cage. The mesh is flush on the outside of the ribs. A baffle 2302 is provided that forms a wall inside the chamber 2204 to one side of the jug inlet 2202 so that effluent progresses around the inside of the chamber in only one direction. Captured particles pass around the filter, collect at the baffle and build up at the far side of the filter away from the inlet. This limits recirculation of the captured particles. The mesh by the inlet is kept clear and clean from particles. Therefore, when wastewater enters the filter chamber it can pass through the mesh. The filter assembly has a cap 2203b to prevent unfiltered effluent overflowing into the outlet. This filter cap can also be removed to allow the user to gain access to the regeneration apparatus for maintenance. The cap is designed in the top of the filter assembly to ensure that no captured effluent can escape through this route during maintenance. The jug 2203 has an open top so that a user can access the interior to remove filtered microplastics. The jug 2203 has an outer rim with a flange 2206. When the jug 2203 is installed in the unit, a lid 2207 is lowered onto the jug. The lid includes a seal 2208 that engages with the flange 2206. A lever 2209 operates a mechanism to lower the lid onto the jug and provide a water-tight seal of the jug into the unit.

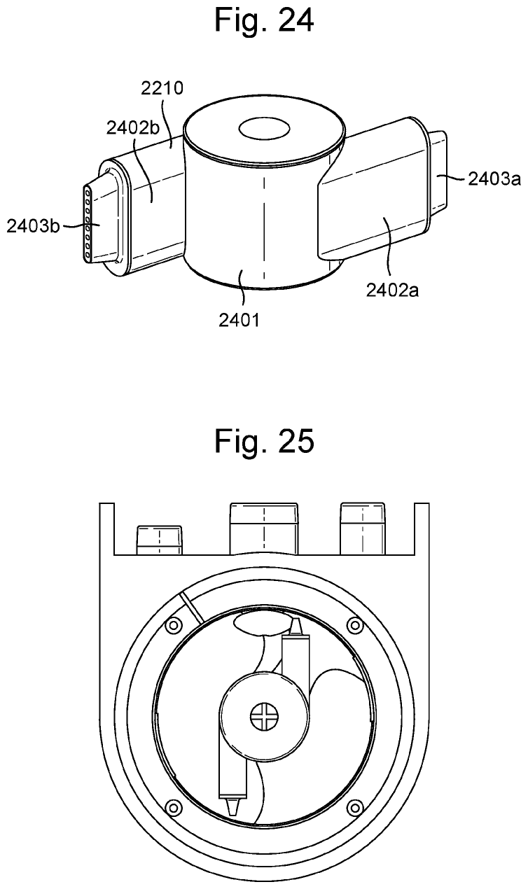

Located within the filter assembly of the jug is a pressure consumption regeneration apparatus comprising a rotatable nozzle assembly 2210 mounted on a hollow spigot 2211. The rotatable nozzle assembly is captive on the spigot by the filter assembly cap 2203b. The spigot is fed by a conduit that is routed through the unit to a recirculating pump 2216a, shown in FIG. 22b, that can provide wash fluid to the nozzle assembly. The nozzle assembly is shown in more detail in FIG. 24. Two hollow arms 2402a, 2402b are tangentially connected to a central hub 2401. The end of each arm has a vertical column of flexible nozzles 2403a, 2403b that are arranged to extend over the height of the mesh. The nozzles are flexible so that any limescale build up can be easily cracked off. The tangential arrangement of the nozzle assembly means that when pressurised fluid is forced through the nozzles by the recirculation pump, it will cause the assembly to rotate at around 30-150 rpm. Rotation is arranged to be in the opposite direction to the flow of fluid around the chamber; in this way, the angle of impact of the jet of fluid emitted from the nozzles is with the flow of effluent, which allows debris that is dislodged to flow further around the mesh than if the angle was against the flow of effluent. FIG. 25 shows the nozzle assembly in place within the jug assembly. The spigot on which the regen apparatus is mounted operates as a plain bearing. It has a bleed path at the upper and lower section that allow an amount of wash fluid to exit. This is limited by a labyrinth seal of grooves. It is important to allow wash fluid to exit here as it ensures that any debris that may pass into this mechanical system can also be passed out and limit the risk of jamming. The grooves are toleranced to allow the largest particle that can fit through the mesh aperture in any orientation to pass through this bearing.

The jug 203 is provided with a moulding 2212 that collects the filtered effluent that has passed through the mesh. This moulding channels effluent to the jug outlet 2213. The jug outlet feeds two reservoirs; a recirculation reservoir 2214 and a drainage reservoir 2215. The recirculation reservoir is connected to the recirculation pump 2216a. The drainage reservoir is connected to a drainage pump 2216b, shown in FIG. 22b. The outlet from the drainage pump feeds into a chamber 2217 that has a one-way valve 2218 to prevent filtered effluent from returning to the reservoirs 2214, 2215. Filtered effluent leaves the unit via outlet 2219.

Upon drainage from the filter unit the reservoirs are arranged to prioritise filling of the recirculation reservoir before the drainage reservoir. This ensures that there is always a supply of wash fluid for recirculation and it is not removed by the drainage pump.

The volume of the recirculation reservoir is designed to ensure a supply of wash fluid that can provide constant recirculation without fully emptying the reservoir. It might be advantageous in some scenarios to limit this and only provide enough wash fluid for a ‘burst’ as the reduction in this volume enables the product size to be reduced.

The volume of the drainage reservoir is designed to ensure any back flowing fluid from the outlet ducting and hose pipe can back fill into this chamber without overflowing. This ensures that the user can remove the filter jug when the product is installed close to the floor level and not result in any flooding.

The geometry of the reservoirs is designed with an angled base and centralized feed point for the pumps. This reduces sedimentation in the tank by removing static flow areas in the tank and creating a dynamic drainage environment that encourages particles to travel to the feed point and be removed by the pump along with any waste water.

The geometry and depth of the reservoirs is further designed to limit vortexing of the pumps which would otherwise reduce their ability to draw water into the pump and reduce their operational efficiency

The inlet 2201 and outlet 2219 of the unit 2100 are connected by a conduit 2220. A dispensing valve, 2221 is provided at the entrance to the conduit 2220. The dispensing valve opens at a predetermined pressure, so that if there is a fault in the unit and pressure builds up, the valve operates and effluent bypasses the filter section of the unit straight to the outlet. One-way valve 2222 is provided to prevent filtered effluent re-circulating and one-way valve 2223 is provided to prevent by-passing effluent to enter the reservoirs. In another embodiment of the design, the user can gain access to the bypass for maintenance, for example to remove a blockage.

An air valve 2224 is provided in the inlet to prevent the recirculation pump and/or the drainage pumps from drawing water out of a connected washing machine, to ensure that there is sufficient water left in the washing machine.

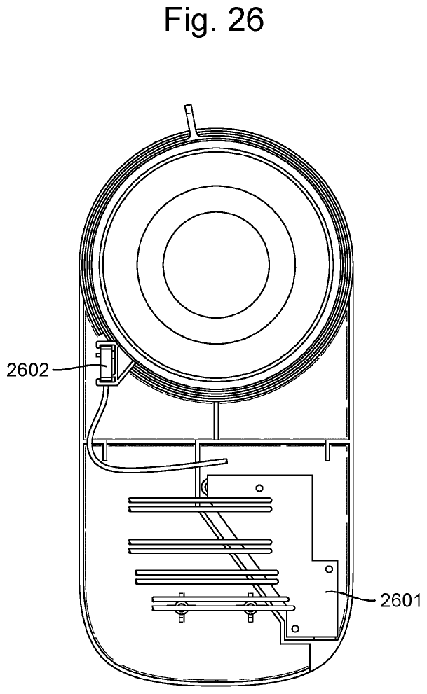

FIG. 26 shows the arrangement of the electronic control system of the unit, mounted on a PCB 2601. Two sensors are provided; i) a capacitive sensor in the inlet or other areas of the ducting depending on the control method and software logic, which detects the presence of effluent and ii) a pressure differential sensor that is arranged to measure the difference in pressure between the two sides of the mesh. The pressure differential sensor can be used to indicate a difference in pressure between each side of the mesh. This can be used to monitor the health of the system and can be used to provide feedback to the logic, such as indicating if the mesh is soon to blind over with debris and regeneration should be activated. A microswitch 2602 is provided that detects when the jug is fully located in the unit. Any other type of sensor may be used to detect mechanical movement, such as an IR sensor. If the jug is not located and the unit is switched on, then an alarm is sounded to alert the user to locate the jug before use. This can also be operated on a timer so that during maintenance the user is reminded to replace the jug and not leave the unit disassembled.

The capacitive sensor is a type of fluid sensor; any other type could be used, such as a float switch.

The electronic system is arranged to operate the unit in numerous modes involving different combinations of sensors and software logic, to optimise the system operation or vary it for differing regional, user, functional or cost requirements. For example, only a capacitive sensor could be used (no pressure sensor) to reduce the number of components and cost. The following are examples of modes of use:

### Example 1—Capacitive Sensor and Pressure Sensor

### Active Filtering:

If the capacitive sensor indicates that there is effluent present at the inlet (i.e. that the washing machine is emptying) and the pressure sensor indicates that the mesh has blinded over, then the drainage pump is activated to drain the unit and the recirculation pump is activated to spray the mesh to remove the debris and regenerate the pressure consumption. Active filtering may run for a set time once it has been triggered.

### Passive Filtering:

If the pressure sensor indicates that the pressure differential is below a threshold and the capacitive sensor is triggered, then passive filtering is initiated. This is where the recirculation pump is turned off and only the drainage pump is operated.

### Drainage Cycle:

If the capacitive sensor indicates that effluent at the input has ceased, then the recirculation pump is operated after a delay, which could be around 100 seconds, to clean the mesh; this delay can be adjusted. Shortly after, for example 2 seconds, the drainage pump is operated to drain the system. The recirculation pump is then turned off after, for example, a further 3 seconds and then the drainage pump is turned off after, for example, 10 seconds. If the capacitive sensor detects input effluent then the drainage cycle is interrupted and the filtering mode is initiated again.

### Standby:

If the capacitive sensor is low, then the recirculation and drain pump are both turned off.

### Example 2—Capacitive Sensor Only

The capacitive sensor is provided on the inlet pipe. When water is detected the pumps are activated until water is not detected anymore. The pumps are programmed to overrun by a predetermined number of seconds to clean the mesh and drain the filter.

### Example 3—Capacitive Sensor with Current Monitoring on the Drainage Pump

The capacitive sensor is provided on the inlet pipe. When water is detected, the drain pump is turned on. If current on the drain pump is low while the fluid sensor is reading high, then the recirculation pump is turned on. The recirculation pump is turned off after a predetermined time while the drain pump is left on.

### Example 4—Integrated in Washing Machine—Pressure Sensor Only

The separator unit may be integrated into a washing machine or other textile processing apparatus. No fluid sensor is required as integration with the washing machine control logic enables the filter to know when water is being pumped into the filter. When fluid is pumped through the filter and the pressure sensor is low, the recirculation pump is not run, but the drain pump is activated. When fluid is being pumped through the filter and the pressure sensor is triggered, then the recirculation pump is run. The washing machine drain cycle can be paused at this point for a few seconds to increase the pressure consumption regeneration effectiveness.

The unit may be used to reduce the water consumption of an existing washing machine or other textile processing equipment, by recirculating the water from the output back into the washing machine. This is possible because the filter removes a high proportion of the debris from the effluent and is therefore very clean. A unit that is integrated into a washing machine could provide this functionality too.

The separator unit could be integrated into a washing machine and used to replace the conventional filter that is used to prevent debris from reaching and damaging the washing machine pump. Furthermore, by replacing an existing filter with the advanced filtering technology disclosed herein, a different washing machine pump could be used altogether, one that operates at a higher efficiency.

A bypass system is an important feature of the systems described above because of the complexity of the elements making up the systems. Should any of these fail then the bypass system ensures that the unit will not flood the owner's property. If, for example, the pressure regeneration system malfunctions, for example the nozzles become blocked, or the nozzle assembly stops rotating for any reason, the sieve structure will become blinded over and fluid will back up into the inlet. Without a bypass system, this backed-up fluid could overflow our of the unit and into the property causing a lot of damage.

As an alternative to regenerating the pressure of the separator unit, a disposable cartridge may be provided. The part of the separator that contains the filtering element, i.e. the sieve structure, could be provided as a cartridge, that is removed and disposed of and replaced with a new one. Alternatively, the cartridge could be sent for cleaning and then re-used.

Wastewater expelled from textile factories is contaminated with microfibers and it is not guaranteed it will be filtered at municipal facilities. When these facilities exist, they may remove up to 98% of microplastics, however what escapes still equates to millions of microfibers every day. Microfibers removed from water may then be passed to the environment as “sewage sludge”, spread on agricultural land as fertiliser. Ultimately microfibers are passed as pollutants into the natural environment—they need to be stopped at source.

Wet-processing factories currently operate in a linear system, whereby microfibre resources are expelled as pollutants from the technical process into the biological environment. Use of the separator system described herein closes the loop into a continued cycle to retain the value of the microfibers within the technical process and stop damage to the biological environment.

An embodiment of the separator system can be retrofitted onto the existing wastewater outlet of wet-processing textile factories to enable microfibre capture at source before pollution of the natural environment can occur.

The separator system can be used to filter microplastics and other micropollutants from environmental drainage systems, such as roadside gullies. A lot of microplastics in the environment break down from larger items of plastic such as car tyres, road surfaces and road markings. After synthetic textiles, tyres are the largest source of microplastics and contain harmful materials such as mineral oils.

Catalytic converters are fitted on most cars and contain highly valuable materials such as platinum, palladium, copper and zinc. During use, small amounts of these metals are lost from cars and fragments are deposited on the road surface. While metal concentrations vary geographically, collection and recycling of these materials not only reduces environmental pollution but can also be a revenue stream in a circular economy.

A larger-scale embodiment of the invention can be applied to the treatment of effluent in Wastewater Treatment Plants. For example, the chamber of the separator could be 1 meter in diameter or 2 meters or greater.

Typical sewage networks are built along one of two designs:
i) Combined sewers. These collect surface water and sewage together, meaning all waste water passes through a Wastewater Treatment Plant (WWTP). During heavy rainfall, it is common for sewers to overflow, releasing untreated sewage and pollution into waterbodies.
ii) Separate sewers. These discharge surface water directly into waterbodies.

In both systems, roadside runoff, i.e. surface water from the roads, is released into the environment. Most roadside gullies have drains located at regular points and these drains have a sediment “pot”, which lets heavy materials like gravel and sand settle to prevent blockage. These hold some micropollutants, but the majority of microplastics and valuable metals are too small and are not retained.

An embodiment of the separation system of the present invention can be retrofitted as an insert into the sediment pot of a drain to filter micropollutants at source. It is designed to fit existing gullies and to be emptied using a mobile vacuum pump.

In another embodiment the system can be used as part of a filtration system for maritime waste disposal. At sea shipping vessels dump wastewater contaminated from activities on the ship, which include microplastic from various sources. The filter system can be applied to filter this effluent prior to disposal and thus combat this pollution source.

1-15. (canceled)

16. A separator suitable for separating solid material from a fluid, the separator comprising:
a chamber with an inlet and an outlet,
a sieve structure forming a permeable barrier between the inlet and the outlet to filter the fluid, the sieve structure thus having an inlet side for unfiltered fluid and an outlet side for filtered fluid, the separator further comprising a filter pressure regeneration apparatus for dislodging filtered material from the sieve structure, wherein the filter pressure regeneration apparatus comprises a conduit and a nozzle assembly having at least one cleaning nozzle for directing fluid towards the outlet side of the sieve structure,
wherein the separator is wherein the sieve structure has a circular cross-section, and
wherein a channel is formed between the chamber and the sieve structure such that in use the fluid is guided circumferentially around the sieve structure through the channel, and
wherein a bypass conduit having a valve is provided between the inlet and the outlet to provide an alternative route for fluid in the event that the flow of fluid is impeded.

17. The separator of claim 16, wherein the bypass conduit includes a pressure-activated valve.

18. The separator of claim 16, wherein the bypass conduit includes a gravity bypass tube.

19. The separator of claim 16, wherein the bypass conduit includes a Pitot tube.

20. The separator of claim 16, wherein the bypass conduit includes a venturi.

21. The separator of claim 16, wherein the bypass system includes an electronically controlled valve.

22. The separator of claim 16, wherein the nozzle assembly comprises a plurality of cleaning nozzles that are rotatable around the central axis of the sieve structure.

23. The separator of claim 16, having a pump in fluid communication with the outlet of the chamber.

24. The separator of claim 23, wherein the pump is arranged to recirculate the filtered fluid to the conduit of the filter pressure regeneration apparatus and/or to drain the separator.

25. The separator of claim 16, wherein an air vent is provided in a conduit between the pump and the filter pressure regeneration apparatus to introduce air into the conduit.

26. The separator of claim 16, wherein a one-way valve is provided such that in use, the one-way valve prevents fluid that has passed through the bypass conduit from returning to the chamber.

27. A washing machine with a separator as claimed in claim 16.

28. A method of operating the separator as claimed in claim 16, comprising the steps of;
filtering fluid through a sieve structure,
allowing the fluid to bypass the sieve structure when the pressure at an inlet of the sieve structure exceeds a predetermined threshold.

29. The method of claim 16 further comprising the step of allowing the fluid to bypass the sieve structure through a pressure-activated valve.

30. The method of claim 16, further comprising the step of detecting the pressure at the inlet using a sensor and controlling an electronic valve in a bypass conduit when the pressure differential reaches the predetermined threshold.
